(19) United States
(12) Patent Application Publication
(10) Pub. No.: US 2014/0137549 A1
(43) Pub. Date: May 22, 2014

(54) HYDRAULIC SYSTEM FOR CONSTRUCTION MACHINERY

(71) Applicants: Sang-Ki Bae, Changwon-si (KR); Joon-Seog Go, Changwon-si (KR)

(72) Inventors: Sang-Ki Bae, Changwon-si (KR); Joon-Seog Go, Changwon-si (KR)

(73) Assignee: VOLVO CONSTRUCTION EQUIPMENT AB, Eskilstuna (SE)

(21) Appl. No.: 14/233,799

(22) PCT Filed: Jul. 26, 2011
(86) PCT No.: PCT/KR2011/005487

§ 371 Date: Jan. 20, 2014

(51) Int. Cl. F15B 9/17; E02F 9/22; F15B 21/08

(52) U.S. Cl. CPC F15B 9/17; F15B 21/08; E02F 9/2264
USPC 60/422; 91/514; 91/530; 60/426

(57) ABSTRACT

Disclosed is a hydraulic system for controlling the degree of openness of an arm regeneration valve by driving an electronic proportional control valve during a combined operation of simultaneously operating an arm and a swing device. The hydraulic system for construction machinery according to the present invention is characterized by comprising: a hydraulic pump; a control valve for controlling the discharge flow from the hydraulic pump; an arm cylinder and a swing motor, each connected to the hydraulic pump; an arm controlling device and a swing controlling device; a pressure detecting means for the hydraulic pump; a controlled amount detecting means for the arm controlling device; a controlled amount detecting means for the swing controlling device; an arm control valve for controlling the driving of the arm cylinder; a swing control valve for controlling the driving of the swing motor; an arm regeneration valve for controlling the pressure at an upstream return passage of the arm control valve when the arm naturally descends; an electronic proportional control valve for outputting a signal voltage for switching the arm regeneration valve; and a controller for performing a control so as to generate a secondary signal voltage by outputting electrical control signals to both the control valve and the electronic proportional control valve so as to correspond to detection signals inputted from the pressure detecting means and controlled amount detecting means.

### FIELD OF THE INVENTION

The present invention relates to a fuel system for an excavator. More particularly, the present invention relates to a hydraulic system for a construction machine, which enables an opening degree of the arm regeneration valve to be controlled by an electronic proportional control valve when a combined operation is performed in which an arm and a swing device are driven simultaneously.

### BACKGROUND OF THE INVENTION

In general, the term regeneration refers to a process in which a hydraulic fluid returned from a return side of a hydraulic actuator is replenished to a flow path on a supply side so as to prevent cavitation due to a shortage of the hydraulic fluid at the supply side and secure the smooth operating speed of the hydraulic actuator.

A hydraulic system for a construction machine in accordance with the prior art as shown in FIG. 1 includes:

a variable displacement hydraulic pump (hereinafter, referred to as “hydraulic pump”) 1;

an arm cylinder 2 and a swing motor 3 that is respectively connected to the hydraulic pump 1;

an arm manipulation device 4 and a swing manipulation device 5 that is configured to output a control signal according to an manipulation amount thereof, respectively;

a pressure detection means 6 that is configured to detect a pressure on an outlet port side of the hydraulic pump 1;

an arm manipulation amount detection means 7 that is configured to detect the manipulation amount of the arm manipulation device 4;

a swing manipulation amount detection means 8, 8a that is configured to detect the manipulation amount of the swing manipulation device 5;

an arm control valve 9 that is shifted in response to the control signal outputted from the arm manipulation device 4 and is configured to control a start, a stop, and a direction change of the arm cylinder 2;

a swing control valve 10 that is shifted in response to the control signal outputted from the swing manipulation device 5 and is configured to control a start, a stop, and a direction change of the swing motor 3;

an arm regeneration valve 11 that is installed in a return flow path 9a on an upstream side of the arm control valve 9 and is configured to control a pressure of the return flow path 9a so that a hydraulic fluid on a small chamber side of the arm cylinder 2 is supplied to a head chamber side through a regeneration flow path 9b during natural descending of an arm;

a control valve 15 that is driven in response to an electric control signal applied thereto and is configured to output a secondary signal pressure to control a flow rate of a hydraulic fluid discharged from the hydraulic pump 1; and

a controller 12 configured to output the electric control signal to the control valve 15 to correspond to detection signals applied thereto from the pressure detection means 6 and the manipulation amount detection means 7, 8 and 8a to control the flow rate of the hydraulic fluid discharged from the hydraulic pump 1 by the secondary signal pressure discharged from a pilot hydraulic pump 16 and generated by the control valve 15.

As shown in FIG. 1, the swing control valve 10 is shifted in a left or right direction on the drawing sheet according to the manipulation of the swing manipulation device 5 so that the swing motor 3 is driven in a forward or reverse direction by a hydraulic fluid supplied thereto from the hydraulic pump 1. At this time, the manipulation amount of the swing manipulation device 5 is detected by the swing manipulation detection means 8 and 8a, which in turn outputs a detection signal for application to the controller 12. In addition, the pressure on the discharge side of the hydraulic pump 1 is detected by the pressure detection means 6, which in turn outputs a detection signal for application to the controller 12.

Simultaneously, the arm control valve 9 is shifted in a right direction on the drawing sheet according to the manipulation of the arm manipulation device 4 so that the arm cylinder 2 is driven in stretchable manner by the hydraulic fluid supplied 30 thereto from the hydraulic pump 1. At this time, the manipulation amount of the arm manipulation device 4 is detected by the arm manipulation detection means 7, which in turn outputs a detection signal for application to the controller 12.

For this reason, the arm and the swing device are driven simultaneously so that a combined operation such as a leveling/flattening process of earth and sand can be performed smoothly.

Since the size of the opening area of the arm regeneration valve 11 is designed small, when the arm descends naturally, a pressure of the return flow path 9a on the upstream side of the arm control valve 9 rises to cause a regeneration hydraulic fluid to be smoothly supplied to a head side of the arm cylinder 2 through the regeneration flow path 9b provided in the arm control valve 9.

In the meantime, a back pressure on a downstream side of the arm cylinder 2 rises to cause a problem in that a digging force of the arm is deteriorated, when an excavation work is performed by the arm. In view of this, when the arm regeneration valve 11 is shifted by the control signal from a supply flow path 13 on the upstream side to cause the pressure on the upstream side of the arm control valve 9 to rise, a problem in that the back pressure on the downstream side of the arm cylinder 2 rises through increase of the opening area of the arm regeneration valve 11 is solved.

In addition, when a combined operation is performed in which the arm and the swing device are driven simultaneously, a driving pressure of the swing motor 2 becomes more than that of the arm cylinder 2. Thus, a pressure according to the manipulation of the swing manipulation device 5 is supplied to the arm regeneration valve 11 through a shuttle valve 14 to thereby improve manipulability.

As described above, when the opening area of the arm regeneration valve 11 is increased during the combined operation in which the arm and the swing device are driven simultaneously, a limitation such as cavitation occurs. For this reason, a pressure loss occurs, leading to a degradation of efficiency. In addition, although the driving speed of the arm can be controlled by the arm regeneration valve 11, there is still a limitation in satisfying all the various different work conditions.

### DETAILED DESCRIPTION OF THE INVENTION

### Technical Problems

Accordingly, the present invention has been made to solve the aforementioned problem occurring in the prior art, and it is an object of the present invention to provide a hydraulic system for a construction machine, in which when a combined operation is performed in which the arm and the swing device are driven simultaneously, an opening degree of the arm regeneration valve can be controlled by the electronic proportional control valve depending on various different work conditions to thereby improve manipulability, and the opening degree of the arm regeneration valve can be increased to reduce a pressure loss.

### Technical Solution

To accomplish the above object, there is provided a hydraulic system for a construction machine in accordance with an embodiment of the present invention, including:
a variable displacement hydraulic pump;
a control valve driven in response to an electric control signal applied thereto and configured to control a flow rate of a hydraulic fluid discharged from the hydraulic pump;
an arm cylinder and a swing motor respectively connected to the hydraulic pump;
an arm manipulation device and a swing manipulation device configured to output a control signal according to an manipulation amount thereof, respectively;
a pressure detection means configured to detect a pressure on an outlet port side of the hydraulic pump;
an arm manipulation amount detection means configured to detect the manipulation amount of the arm manipulation device;
a swing manipulation amount detection means configured to detect the manipulation amount of the swing manipulation device;
an arm control valve shifted in response to the control signal outputted from the arm manipulation device and configured to control a start, a stop, and a direction change of the arm cylinder;
a swing control valve shifted in response to the control signal outputted from the swing manipulation device and configured to control a start, a stop, and a direction change of the swing motor;
an arm regeneration valve configured to control a pressure of a return flow path on an upstream side of the arm control valve so that a hydraulic fluid on a small chamber side of the arm cylinder is supplied to a head chamber side through a regeneration flow path during natural descending of an arm;
an electro proportional control valve driven in response to the electric control signal applied thereto and configured to output a secondary signal pressure to shift the arm regeneration valve; and
a controller configured to output the electric control signal to the control valve and the electro proportional control valve to correspond to detection signals applied thereto from the pressure detection means and the manipulation amount detection means to control the electro proportional control valve to generate the secondary signal pressure.

In accordance with a preferred embodiment of the present invention, when the detection signal according to the manipulation amount of the swing manipulation device and the detection signal according to the manipulation amount of the arm manipulation device are applied to the controller, the controller outputs the control signal to the electro proportional control valve so as to perform a swing preference function through reduction of an opening area of the arm regeneration valve.

In addition, when the pressure detection signal that is detected on the discharge side of the hydraulic pump is applied to the controller, if the detection signal exceeds a preset value, the controller outputs the control signal to the electro proportional control valve so as to increase the opening area of the arm regeneration valve.

### Advantageous Effect

The hydraulic system for a construction machine in accordance with an embodiment of the present invention as constructed above has the following advantages.

When a combined operation is performed in which the arm and the swing device are driven simultaneously, an opening degree of the arm regeneration valve is controlled by the electronic proportional control valve depending on various different work conditions to thereby improve manipulability. In addition, if the pressure on the discharge side of the hydraulic pump exceeds a preset value, the opening degree of the arm regeneration valve can be increased to reduce a pressure loss.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a hydraulic circuit diagram showing a hydraulic system for a construction machine in accordance with the prior art; and

FIG. 2 is a hydraulic circuit diagram showing a hydraulic system for a construction machine in accordance with an embodiment of the present invention.

### EXPLANATION ON REFERENCE NUMERALS OF MAIN ELEMENTS IN THE DRAWINGS

1: variable displacement hydraulic pump

2: arm cylinder

3: swing motor

4: arm manipulation device

5: swing manipulation device

6: pressure detection means

7: arm manipulation amount detection means

8,8a: swing manipulation amount detection means

9: arm control valve

10: swing control valve

11: arm regeneration valve

12: controller

15: control valve

16: pilot hydraulic pump

17: electro proportional control valve

### PREFERRED EMBODIMENTS OF THE INVENTION

Now, preferred embodiments of the present invention will be described in detail with reference to the accompanying drawings. The matters defined in the description, such as the detailed construction and elements, are nothing but specific details provided to assist those of ordinary skill in the art in a comprehensive understanding of the invention, and the present invention is not limited to the embodiments disclosed hereinafter.

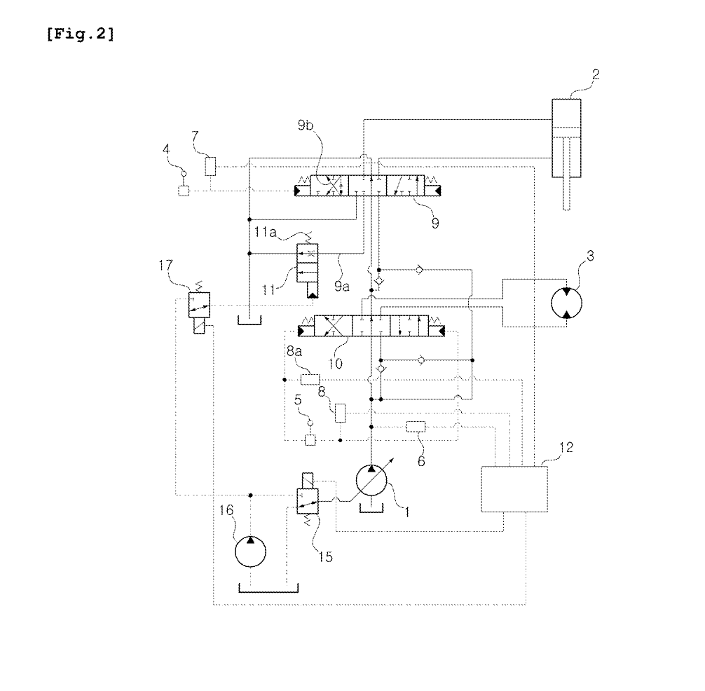

A hydraulic system for a construction machine in accordance with an embodiment of the present invention as shown in FIG. 2 includes:

a variable displacement hydraulic pump (hereinafter, referred to as “hydraulic pump”) 1;

an arm cylinder 2 and a swing motor 3 that is respectively connected to the hydraulic pump 1;

an arm manipulation device 4 and a swing manipulation device 5 that is configured to output a control signal according to an manipulation amount thereof, respectively;

a pressure detection means 6 that is configured to detect a pressure on an outlet port side of the hydraulic pump 1;

an arm manipulation amount detection means 7 that is configured to detect the manipulation amount of the arm manipulation device 4;

a swing manipulation amount detection means 8, 8a that is configured to detect the manipulation amount of the swing manipulation device 5;

an arm control valve 9 that is shifted in response to the control signal outputted from the arm manipulation device 4 and is configured to control a start, a stop, and a direction change of the arm cylinder 2;

a swing control valve 10 that is shifted in response to the control signal outputted from the swing manipulation device 5 and is configured to control a start, a stop, and a direction change of the swing motor 3;

an arm regeneration valve 11 that is installed in a return flow path 9a on an upstream side of the arm control valve 9 and is configured to control a pressure of the return flow path 9a so that a hydraulic fluid on a small chamber side of the arm cylinder 2 is supplied to a head chamber side through a regeneration flow path 9b during natural descending of an arm;

a control valve 15 that is driven in response to an electric control signal applied thereto and is configured to control a flow rate of a hydraulic fluid discharged from the hydraulic pump 1;

an electro proportional control valve 17 that is driven in response to the electric control signal applied thereto and is configured to output a secondary signal pressure to shift the arm regeneration valve 11; and

a controller 12 configured to output the electric control signal to the control valve 15 and the electro proportional control valve 17 to correspond to detection signals applied thereto from the pressure detection means 6 and the manipulation amount detection means 7, 8 and 8a to control the electro proportional control valve 17 to generate the secondary signal pressure.

When the detection signal according to the manipulation amount of the swing manipulation device 5 and the detection signal according to the manipulation amount of the arm manipulation device 4 are applied to the controller 12, the controller 12 outputs the control signal to the electro proportional control valve 17 so as to perform a swing preference function through reduction of an opening area of the arm regeneration valve 11.

When the pressure detection signal that is detected on the discharge side of the hydraulic pump 1 is applied to the controller 12, if the detection signal exceeds a preset value, the controller 12 outputs the control signal to the electro proportional control valve 17 so as to increase the opening area of the arm regeneration valve 11.

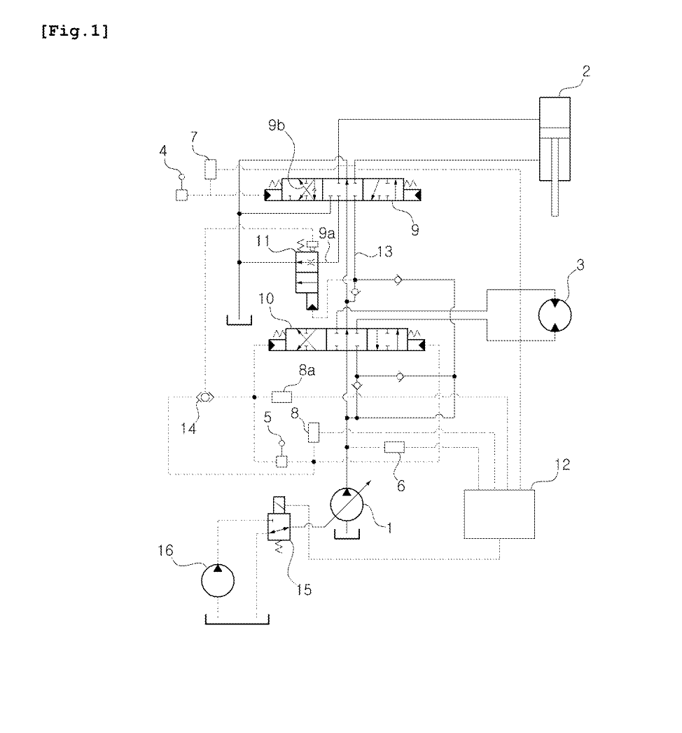

In this case, the remaining configuration of the hydraulic system shown in FIG. 2 is the same as a configuration of the hydraulic system shown in FIG. 1 except the arm regeneration valve 11 that is installed in the return flow path 9a on the upstream side of the arm control valve 9 and is shifted in response to the separate secondary signal pressure applied thereto from the electro proportional control valve 17, and the electro proportional control valve 17 that is installed in a flow path between the arm regeneration valve 11 and the control valve 15 and is driven in response to the electric control signal from the controller 12 to output the secondary signal pressure. Thus, a detailed description on the remaining configuration thereof will be omitted and the same elements are denoted by the same reference numerals.

Hereinafter, a use example of the hydraulic system for a construction machine in accordance with an embodiment of the present invention will be described in detail with reference to the accompanying drawings.

As shown in FIG. 2, the swing control valve 10 is shifted in a left or right direction on the drawing sheet according to the manipulation of the swing manipulation device 5 so that the swing motor 3 is driven in a forward or reverse direction by a hydraulic fluid supplied thereto from the hydraulic pump 1. At this time, the manipulation amount of the swing manipulation device 5 is detected by the swing manipulation detection means 8, 8a, which in turn outputs a detection signal for application to the controller 12. In addition, the pressure on the discharge side of the hydraulic pump 1 is detected by the pressure detection means 6, which in turn outputs a detection signal for application to the controller 12.

Simultaneously, the arm control valve 9 is shifted in a right direction on the drawing sheet according to the manipulation of the arm manipulation device 4 so that the arm cylinder 2 is driven in stretchable manner by the hydraulic fluid supplied thereto from the hydraulic pump 1. At this time, the manipulation amount of the arm manipulation device 4 is detected by the arm manipulation detection means 7, which in turn outputs a detection signal for application to the controller 12.

For this reason, the arm and the swing device are driven simultaneously so that a combined operation such as a leveling/flattening process of earth and sand can be performed smoothly.

In this case, when the detection signal according to the manipulation amount of the swing manipulation device 5 and the detection signal according to the manipulation amount of the arm manipulation device 4 are applied to the controller 12, a driving pressure of the swing motor 2 becomes more than that of the arm cylinder 2 to cause a spool opening area of the arm regeneration valve 11 to be reduced (i.e., referring to a state shown in FIG. 2). In this case, a control signal pressure from the electro proportional control valve 17 is not applied to the arm regeneration valve 11. Thus, the driving of the swing motor 3 can be controlled preferentially with respect to the driving of the arm cylinder 2.

In the meantime, when the pressure on the discharge side of the hydraulic pump 1 is detected by the pressure detection means 6 and a pressure detection signal from the pressure detection means 6 is applied to the controller 12, if the detection signal exceeds a preset value, the controller 12 outputs the control signal to the electro proportional control valve 17 so as to increase the opening area of the arm regeneration valve 11. Thus, a secondary signal pressure generated by the electro proportional control valve 17 is applied to an opposite side to a valve spring 11a of the arm regeneration valve 11 to cause the spool of the arm regeneration valve 11 to be shifted in an upward direction on the drawing sheet. Like this, the opening area of the arm regeneration valve 11 is controlled to be increased so that a pressure loss can be reduced.

While the present invention has been described in connection with the specific embodiments illustrated in the drawings, they are merely illustrative, and the invention is not limited to these embodiments. It is to be understood that various equivalent modifications and variations of the embodiments can be made by a person having an ordinary skill in the art without departing from the spirit and scope of the present invention. Therefore, the true technical scope of the present invention should not be defined by the above-mentioned embodiments but should be defined by the appended claims and equivalents thereof.

### INDUSTRIAL APPLICABILITY

As described above, according to the hydraulic system for a construction machine in accordance with an embodiment of the present invention, when a combined operation is performed in which the arm and the swing device are driven simultaneously such as a leveling/flattening process of earth and sand, an opening degree of the arm regeneration valve is controlled by the electronic proportional control valve depending on various different work conditions to thereby improve manipulability. In addition, if the pressure on the discharge side of the hydraulic pump exceeds a preset value, the opening degree of the arm regeneration valve can be increased to reduce a pressure loss.

1. A hydraulic system for a construction machine comprising:
a variable displacement hydraulic pump;
a control valve driven in response to an electric control signal applied thereto and configured to control a flow rate of a hydraulic fluid discharged from the hydraulic pump;
an arm cylinder and a swing motor respectively connected to the hydraulic pump;
an arm manipulation device and a swing manipulation device configured to output a control signal according to an manipulation amount thereof, respectively;
a pressure detection means configured to detect a pressure on an outlet port side of the hydraulic pump;
an arm manipulation amount detection means configured to detect the manipulation amount of the arm manipulation device;
a swing manipulation amount detection means configured to detect the manipulation amount of the swing manipulation device;
an arm control valve shifted in response to the control signal outputted from the arm manipulation device and configured to control a start, a stop, and a direction change of the arm cylinder;
a swing control valve shifted in response to the control signal outputted from the swing manipulation device and configured to control a start, a stop, and a direction change of the swing motor;
an arm regeneration valve configured to control a pressure of a return flow path on an upstream side of the arm control valve so that a hydraulic fluid on a small chamber side of the arm cylinder is supplied to a head chamber side through a regeneration flow path during natural descending of an arm;
an electro proportional control valve driven in response to the electric control signal applied thereto and configured to output a secondary signal pressure to shift the arm regeneration valve; and
a controller configured to output the electric control signal to the control valve and the electro proportional control valve to correspond to detection signals applied thereto from the pressure detection means and the manipulation amount detection means to control the electro proportional control valve to generate the secondary signal pressure.

2. The hydraulic system for a construction machine according to claim 1, wherein when the detection signal according to the manipulation amount of the swing manipulation device and the detection signal according to the manipulation amount of the arm manipulation device are applied to the controller, the controller outputs the control signal to the electro proportional control valve so as to perform a swing preference function through reduction of an opening area of the arm regeneration valve.

3. The hydraulic system for a construction machine according to claim 1, wherein when the pressure detection signal that is detected on the discharge side of the hydraulic pump is applied to the controller, if the detection signal exceeds a preset value, the controller outputs the control signal to the electro proportional control valve so as to increase the opening area of the arm regeneration valve.
